(19) United States
(12) Patent Application Publication
(10) Pub. No.: US 2017/0286267 A1
(43) Pub. Date: Oct. 5, 2017

(54) FAST AND EFFICIENT CONTINUOUS INTEGRATION TEST SYSTEM FOR LARGE SCALE SERVICES

(71) Applicant: Google Inc., Mountain View, CA (US)

(72) Inventors: Sonal JAIN, Encino, CA (US); Nathan BAIN, San Jose, CA (US); Panchao YANG, Sunnyvale, CA (US)

(73) Assignee: Google Inc., Mountain View, CA (US)

(21) Appl. No.: 15/088,891

(22) Filed: Apr. 1, 2016

(51) Int. Cl. G06F 11/36

(52) U.S. Cl. CPC G06F 11/3664; G06F 11/3684; G06F 11/3688

(57) ABSTRACT

Methods and systems for implementing proxy layers an a proxy layer management framework for performing integration testing of test components in a target test environment. Proxy layers are established between components that interact in a system and provide an interface based on a communication protocol, such as HTTP or RPC. Proxy layers axe configured, via a proxy layer manager to reroute communication, based on the communication protocol, to and from test components to simulate integration testing of the components in the target environment. Proxy layers may also apply rules that reroute traffic based on certain conditions for more effective, safer, and specific testing. Also, the routed communications may be traced and logged for testing and debugging.

### BACKGROUND

Large-scale software systems, like YouTube or Facebook, have hundreds of software components that work together to provide the end-user experience. Components of large-scale software systems work together to provide the various functionalities of the overall system. For example, some components of a large-scale video system may handle requests and responses between a web user interface and a database storing video data, other components may handle security aspects of network communication, and still other components may handle user statistics and tracking of video views.

Each component in a large-scale system may be developed and deployed independently from the other components, making development of the overall system fast and efficient. Even so, it is imperative that the components work together to provide system functionality. Although independent development and deployment of components is beneficial, this individual development process creates challenges in testing and validating the functionality and performance in the overall software system where multiple components are simultaneously being developed and deployed.

One way to address the challenges of testing is to create a testing environment that simulates the target environment and deploy components within that environment. By creating a testing environment that simulates a production environment, developers and testers can analyze and evaluate how well components perform their intended functions and interact with one another. However, this approach has several limitations. First, the creation of a testing environment can require substantial time and system resources depending on the size and complexity of the software system. Second, it is nearly impossible to replicate the type and number of interactions a test component will receive once it is deployed into a target environment, like a production environment. Another problem is that, the dynamic state of a software system may be constantly updated, making it less feasible to maintain a suitable test environment.

What is needed is a method or system to allow testing of one or more components in in a dynamic target environment without requiring replicating the whole target environment.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

In general, one aspect of the subject matter described in this specification can be embodied in a proxy layer management system for testing a component in a software system. The proxy layer management system may include one or more processing devices and one or more storage devices storing instructions that, when executed by the one or more processing devices, cause the one or more processing devices to perform an example method. An example method may establish a target test environment, which includes multiple components that interact with each other via proxy layers; add a test component having functionality that corresponds to a specific target component in the target test environment; configure the proxy layers associated with the specific target component to route traffic intended for the specific target component to the test component, and receive traffic from the test component; execute one or more tests in the target test environment on the test component; and route traffic, via the proxy layers, between the test component and one or more components of the target test environment.

These and other embodiments can optionally include one or more of the following features: a proxy layer manager to configure the routing settings of the proxy layers in the target test environment; a web front end for managing and configuring the routing settings of the proxy layer manager in the target test environment; a web from end for managing and configuring the routing settings of the proxy layers in the target test environment; applying routing rules to the proxy layers for rule-based routing of traffic through the proxy layers; routing rules configured to route traffic from some users to the test component and traffic from other users to the specific target component; generating trace and session data of traffic between the proxy layers; a service manager to launch and manage the test component in the target test environment; adding a test component may include adding multiple test components that each contain a portion of functionality of the specific target component in the target environment; and adding a test component may include adding a single test component that contains functionalities of multiple specific target components in the target environment.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the disclosure will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a diagram illustrating a test component and a system in a target test environment with existing components, according to one or more embodiments described herein.

FIG. 2A is a diagram illustrating a conventional example embodiment of a test component deployed in a target test environment and replacing a corresponding original component, according to one or more embodiments described herein.

FIG. 2B is s diagram illustrating a conventional example embodiment of a test component deployed into a target test environment that is a copy of a target component, according to one or more embodiments described herein.

FIG. 3A is a diagram illustrating proxy layers between all components in a target test environment, according to one or more embodiments described herein.

FIG. 3B is a diagram illustrating proxy layers for a test component in a target test environment, according to one or more embodiments described herein.

FIG. 3C illustrates a modified target environment of test components and an original component with a many-to-one relationship, according to one or more embodiments described herein.

FIG. 3D illustrates a modified target environment of a test component and multiple original components with a one-to-many relationship, according to one or more embodiments described herein.

FIG. 4 is a flow diagram illustrating the testing of a test component in a target test environment with proxy layers, according to one or more embodiments described herein.

FIG. 5A is a system diagram illustrating a proxy layer manager system including a web front end, according to one or more embodiments described herein.

FIG. 5B is a flow diagram of a configuration of a proxy layer via a web front end, according to one or more embodiments described herein.

FIG. 5C is a flow diagram of retrieving debug data via a web front end, according to one or more embodiments described herein.

FIG. 6 is a block diagram illustrating an exemplary computing device.

The headings provided herein are for convenience only and do not necessarily affect the scope or meaning of the claims.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples and embodiments will now be described. The following description provides specific details for a thorough understanding and enabling description of these examples and embodiments. One skilled in the relevant art will understand, however, that the various embodiments described herein may be practiced without many of these details. Likewise, one skilled in the relevant art will also understand that the various embodiments described herein can include many other obvious features not described in detail herein. Additionally, some well-known structures or functions may not be shown or described in detail below, so as to avoid unnecessarily obscuring the relevant description.

Integration testing of components is the phase in software testing in which individual software components are combined and tested as a group. It occurs after unit testing and before validation testing. The disclosed embodiment allow for validating one or more software components in a large scale system end-to-end without the need for replicating and running all parts the system in a new replicated test environment. The disclosed embodiments, using proxy layers, allows testing new versions of components in large scale systems to test performance and functionality of test components in a target environment, like a production or quality assurance (QA) environment. Integration testing of these test components is achieved, as described in more detail below, by creating proxy layers for communication between components which interact with each other to build the whole system.

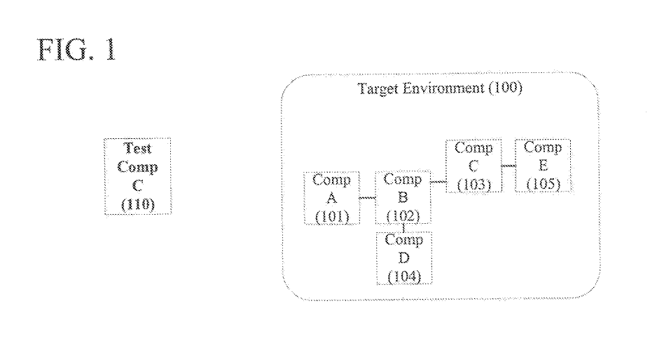

FIG. 1 is a diagram illustrating a test component, Test Comp C (110), and a target test environment, Target Environment (100), with a system deployed in the environment that includes multiple existing components (101-105), according to one or more embodiment described herein. The target test environment, Target Environment (100), hosts a large-scale system with a set of components (101-105) that interact with each other. The various components (101-105) perform various tasks of the software system in the Target Environment (100). The more production-like a target test environment is, such as a Quality Assurance (QA) or User Acceptance Testing (UAT) environment, the more beneficial and effective that environment will be for integration testing. As a best practice, a Quality Assurance (QA) environment may be used as a target test environment for testing of components, although, it is not required. In other example embodiments, the production environment itself or other non-production lower environments, such as development or UAT environments, may be used.

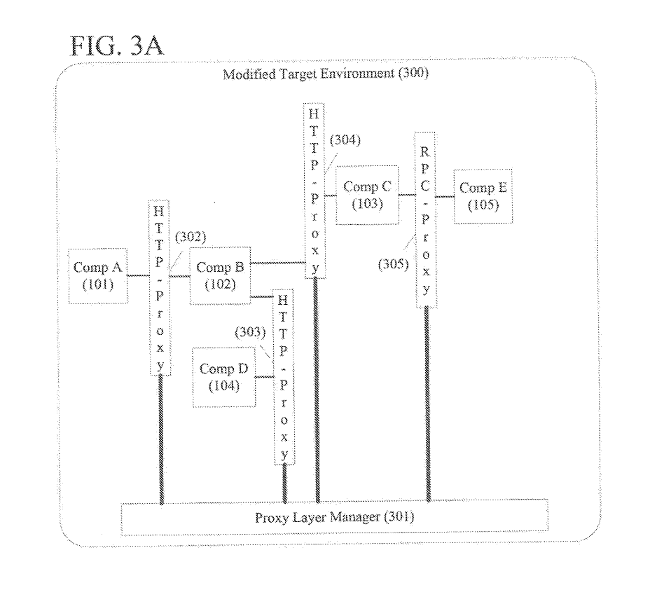

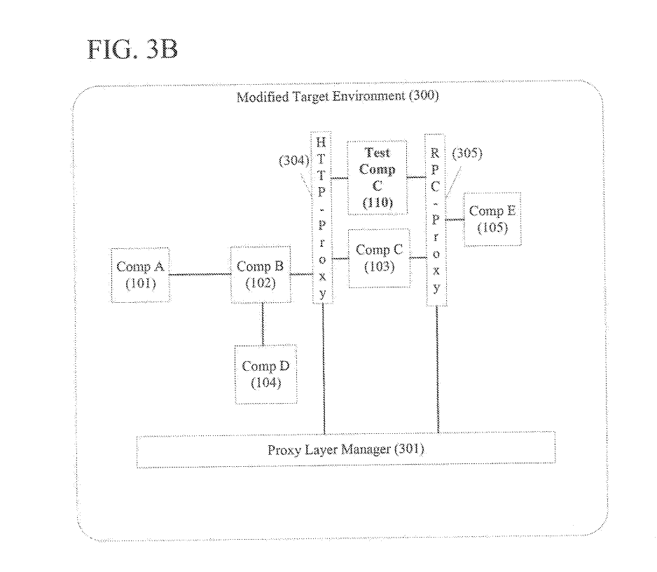

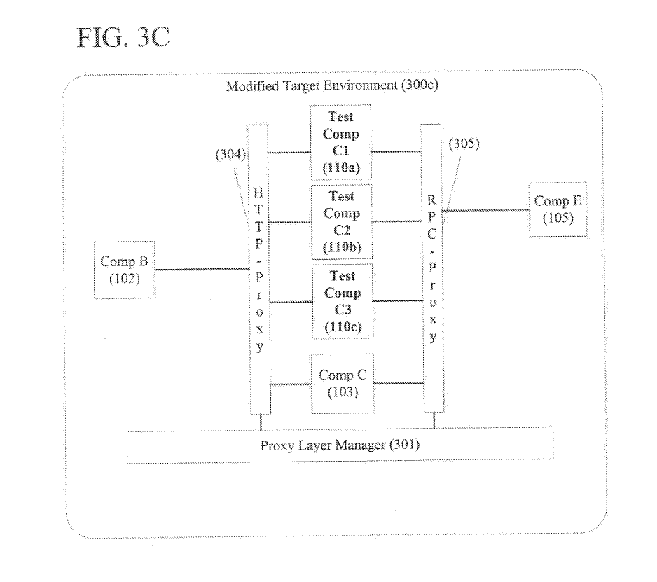

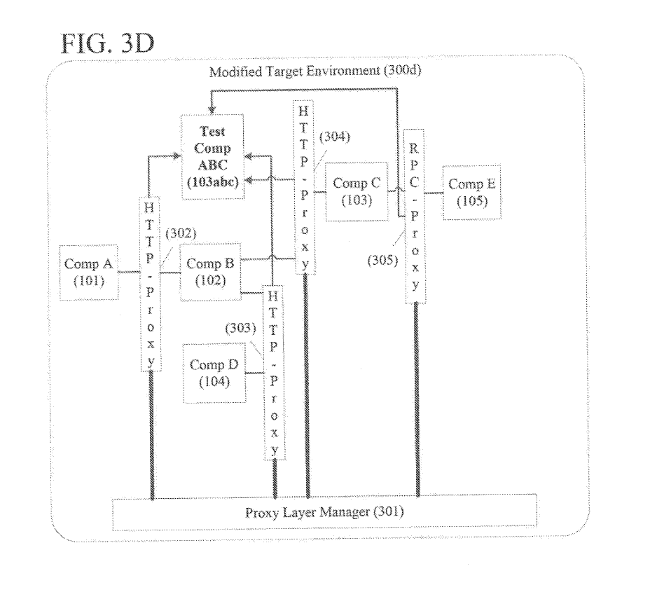

FIG. 1, the test component, Test Comp C (110), is a test component which is intended for integration testing in the target test environment, Target Environment (100). There may be many reasons for developing a new component, such as improving performance, adding new features, or fixing bugs. Once a component has been created or updated, it is important to test how the component interacts with other existing components in the overall system. Here, Test Comp C (110) is a new version of the original Comp C (103) in the Target Environment (100), and based on successful testing would replace Comp C (103) in the Target Environment (100). In this example embodiment, the original component and the test component have a one-to-one relationship. In other example embodiments, further described and illustrated in relation to FIGS. 3C and 3D, the relationship between test components and original components may be one-to-many (i.e., one test component intended to replace multiple original components) or many-to-one (i.e., multiple test components intended to replace one original component.) As would be understood by a person of ordinary skill in the art, in such example cases, filters or rules may be implemented to route traffic to the appropriate components.

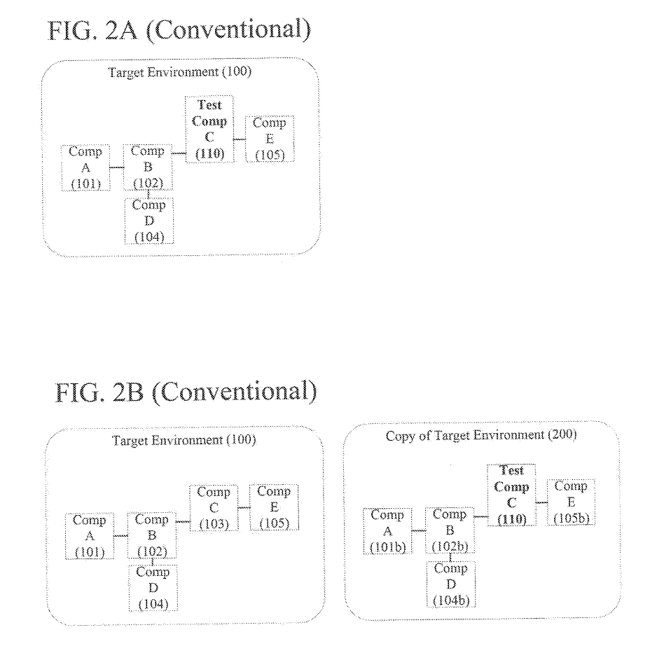

FIG. 2A is a diagram illustrating a conventional example embodiment of a test component, Test Comp C (110), deployed in a target test environment, Target Environment (100), and replacing a corresponding original component, Comp 3 (103). In this conventional method of performing integration testing of a component, Test Comp C (110) replaces the original Comp C (103) and alters the Target Environment (100) for all users of that environment. Alternatively, Test Comp C (110) may replace the original Comp C (103) and alter the Target Environment (100) for only a subset of users of that environment, with other users still using original Comp C (103) in their execution paths.

This conventional approach has several limitations and downsides. First, the permissions necessary to overwrite an existing component for an environment may not even be available as it violates best practices in preserving the integrity of a production environment or production-like test environment. Second, this conventional approach potentially irreversibly allows harmful components to break a previously stable environment. Third, to mitigate such potential permanent effects, the conventional approach would require backup-restore steps to be implemented, requiring significant time and effort, and potential down-time of an environment depending on the complexity of the software system.

Another conventional method for integration testing is to replicate a production-like environment for testing purposes, described here in reference to FIG. 2B. FIG. 2B is a diagram illustrating a conventional example embodiment of a test component, Test Comp C (110), integrated into a replicated target test environment, Copy of Target Environment (200), according to one or more embodiments described herein. In this conventional approach, the original target test environment, Target Environment (100), is not altered or modified in any way. Target Environment (100) illustrated here still retains the original components (101-105) and structure as illustrated in FIG. 1. Instead, a copy of the target test environment, Copy of Target Environment (200), is created. Copy of Target Environment (200) contains identical copies of components. Comp A (101b), Comp B (102b), Comp D (104b), and Comp E (105b) from Target Environment (100), except Comp C has been replaced by Test Comp C (110). This approach allows integration testing of Test Comp C (110) with the other existing components in the Copy of Target Environment (200). Although this approach protects the integrity of the original Target Environment (100), it still has its own limitations and downsides.

First replicating and hosting an existing large-scale software system may be significantly burdensome and infeasible, requiring significant time and system resources depending on the complexity of the online software system. Generally, such systems may be maintained and actively developed by hundreds or even thousands of active developers constantly making changes to the software system, making it extremely challenging, if not impossible, to fully replicate test environments for individual or groups of users. Second, this approach may still not provide test cases or simulate user requests that may be received in an original target environment. That is, some user requests and interactions that occur between components in the Target Environment (100) may not necessarily occur in the newly created replicated environment Copy of Target Environment (200); thus, resulting in inferior and insufficient integration testing of Test Comp C (110). The disclosure provides a solution that addresses the limitations of the above conventional approaches.

FIG. 3A is a Modified Target Environment (300) that includes a software system with a proxy layer manager (301), and proxy layers (302-305) between system components (101-105) that interact with each other, according to one or more embodiments described herein. In this example embodiment, a proxy layer exists between each pair of components that interact with one another other. The proxy layers (302-305) between the components manage the communication between components based on the appropriate communication protocol, such as HTTP, RPC, SOAP, TCP/IP, etc. The example protocols illustrated herein should not be construed to limit the scope of the invention. The type of proxy layers here, i.e. HTTP and RPC, may vary based on the implementation of the components, the environment, and the software system, and may depend on the protocols that are suitable for managing the communication among components.

In FIG. 3A, an HTTP Proxy Laser (302) exists between Comp A (101) and Comp B (102); an HTTP Proxy Laser (304) exists between Comp B (102) and Comp C (103); an HTTP Proxy Layer (303) exists between Comp B (102) and Comp D (104); and an RPC Proxy Layer (305) exists between Comp C (103) and Comp E (105). Each of the proxy layers may also be connected to the Proxy Layer Manager (301) that may manage the routing configurations to the connected proxy layers (302-305). In this example embodiment, all the components (101-105) are connected via proxy layers (302-305) and therefore may have corresponding test components.

This approach addresses the several limitations described in the above conventional methods. First, the permissions limiting or denying access to delete or overwrite existing system components, i.e. components Comp A-E (101-105), are no longer an issue since those components are left intact. Second, the risk of the potential permanent impact of a harmful test component disrupting a stable environment is lessened, as the original components are retained in the system. Third, this approach no longer requires cumbersome backup and restore procedures as the original components, Comp A-E (101-105), are not altered and may continue to function as in the original system. Finally, this approach provides significant savings in time and system resources in allowing dynamic testing of components in a target environment.

FIG. 3B is a Modified Target Environment (300) with a proxy layer manager (301), proxy layers (304-305) associated with Comp C (103) and test component, Test Comp C (110), according to one or more embodiments described herein. In this example embodiment, the Modified Target Environment (300) contains all the original components, Comp A-E (101-105), and also the test component, Test Comp C (110), in a single environment. For clarity, this example embodiment only depicts the proxy layers (304-305) associated with Comp C (103) and Test Comp C (110), the components which are the focus of the integration testing in this ease. Here, Comp C (103) interacts with Comp B (102) via HTTP protocol, thus a HTTP Proxy Layer (304) is established between the two components. Also, Comp C (103) interacts with Comp E (105) via RPC protocol, thus an RPC Proxy Layer (305) is established between the two components. Here, the test component, Test Comp C (110), corresponds to Comp C (103) in the Modified Target Environment (300). Thus, the proxy layers associated with Comp C (103) are configured to route traffic either between Comp C (103) and the proxy layers (304, 305) or between Test Comp C (110) and the proxy layers (304, 305). The Proxy Layer Manager (301) may manage the proxy layers in an environment and may configure the routing of the proxy layers.

For integration testing of Test Comp C (110), the Proxy Layer Manager (301) may configure the HTTP Proxy Layer (304) to reroute all or specific traffic between Comp B (102) and Comp C (103) to Comp B (102) and Test Comp C (110). And configure the RPC Proxy Layer (305) to reroute all or specific traffic between Comp E (105) and Comp C (103) to Comp C (105) and Test Comp C (110). If rules are implemented for proxy layers, based on the rules, specific traffic will either route between the test component or between the original corresponding component. This configuration allows full integration testing of test component Test Comp C (110) in the Modified Target Environment (300) without significantly or permanently altering the functionality of the existing components (101-105) in the target test environment and does not require the costly replication of the Target Environment (100).

This approach also allows implementation of rules in the proxy layers which provide significant other advantages that do not exist in conventional approaches. Rules may be created in the proxy layers so that only certain traffic, based on a rule, is routed to the original component, or test components. As noted above regarding rules, rules may be implemented based specific users, groups, client/devices, and sessions. For example, a rule may be configured so that only requests from developer-users are routed to the test components, so as to not interfere with other users accessing the target environment. Another example rule may be configured so that only non-local user requests are rerouted to the test component to further minimize the disruption to a broader range of users. Another rule, for example in an online shopping software system, like Amazon, may be that requests related to customer data will only be routed to secure proxy layers and secure components to ensure privacy. The design and configuration of rules may vary based on the software system.

FIG. 3C illustrates a modified target environment of test components and an original component with a many-to-one relationship, according to one or more embodiments described herein. Here, the Modified Target Environment (300c) contains three test components. TestCompC1 (110), TestCompC2 (110b), and TestCompC3 (110e) that are new versions of CompC (103) in the Modified Target Environment (103). The multiple test components (110a-c) may each contain a portion of functionality of the specific target component, CompC (103), in the Modified Target Environment (300c). The proxy layers (303-305), based on configured rules, may determine which or the test components (110a-c) or the original component (103) the traffic should be routed through. This example embodiment allows testing of multiple versions of test components (110a-c) using proxy layers (304-305).

FIG. 3D illustrates a modified target environment of a test component and multiple original components with a one-to-many relationship, according to one or more embodiments described herein. Here, one test component. TestCompABC (103abc) is a new version of components CompA (101), CompB (102), and CompC (103). The single test component, TestCompABC (103abc) may contain various functionalities of the multiple specific target components (101-103) in the Modified Target Environment (300d). In this example embodiment, the test component, TestCompABC (103abc), may be replacing three original components (101-103). Thus, the proxy layers (302-305) associated with each of the original components (101-103) may be configured to route traffic, originally intended for components CompA (101), CompB (102), and CompC (103), through TestCompABC (103abc). Thus, CompA's (101) proxy layers (302) are connected to TestCompABC (103abc); CompB's (102) proxy layers (302, 303) are connected to TestCompABC (103abc); and CompC's (103) proxy layers (304, 305) are connected to TestCompABC (103abc). This example case allows testing a component that is replacing multiple original components.

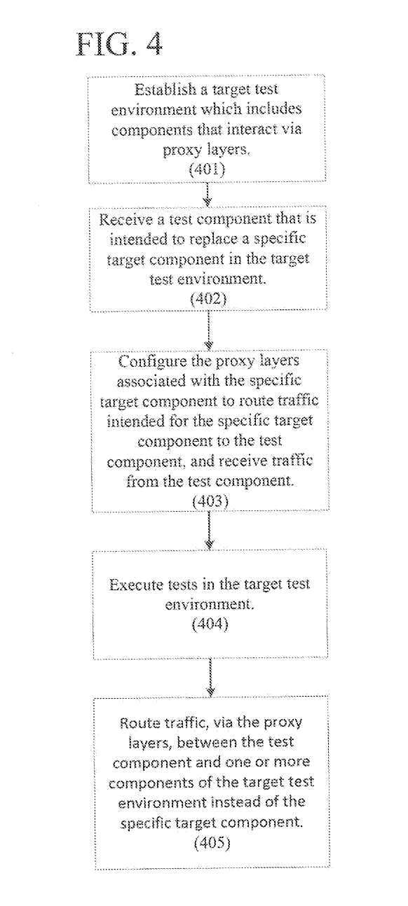

FIG. 4 is a flow diagram illustrating the testing of a test component in a target test environment with proxy layers, according to one or more embodiments described herein. In step 401, a target test environment is established which includes components that interact with each other via proxy layers. In step 402, a test component is received in the target test environment that is intended to replace a specific target component in that target test environment. In step 403, the proxy layers associated with the specific target component are configured to route traffic intended for the specific target component to the test component, and configured to receive the traffic from the test component. In step 404, one or more tests are executed in the target test environment. Finally, in step 405, traffic is routed, via the proxy layers, between the test component and one or more components of the target test environment instead of the specific target component.

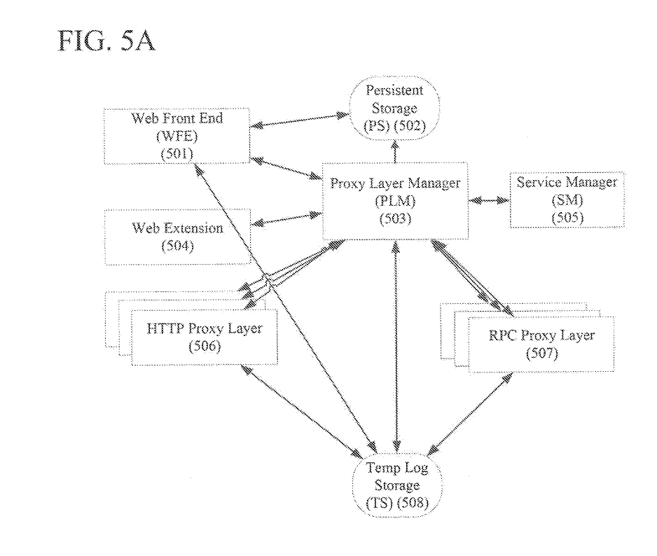

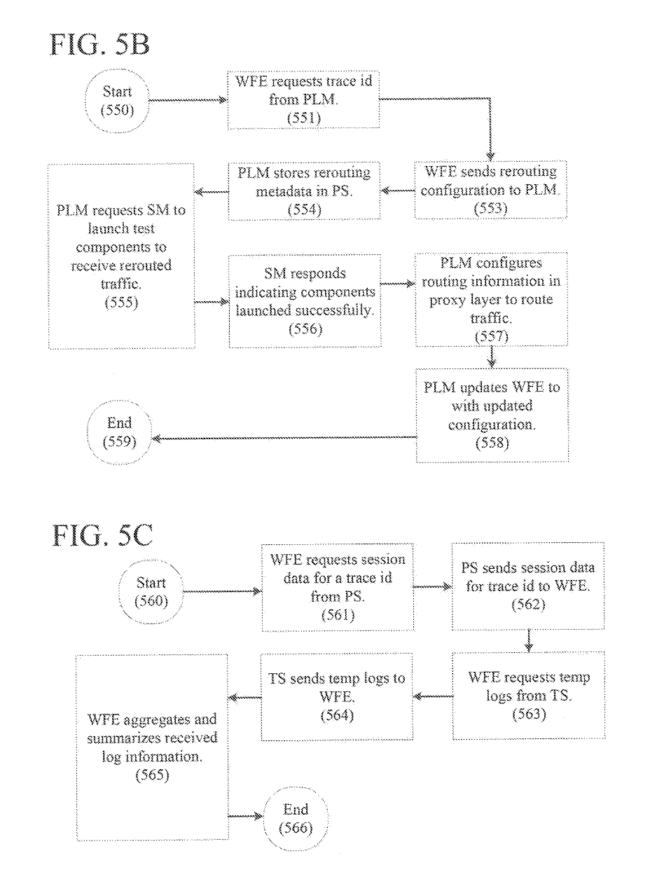

FIG. 5A is a system diagram illustrating a proxy layer manager system including a web front end (501), according to one or more embodiments described herein. A system may include a web front end (501), a web extension (504), persistent storage (502), and temporary log storage (508). A system may also include a proxy layer manager (503), proxy layers (506-507), and a service manager (505).

A web front end (501) may be a user interface to configure and manage the proxy layer manager (503) and the proxy layers (506-507). A web extension (504) may also be used to manage and configure proxy layers (506-507) and provide a one-click solution to deploy test target components and configure the proxy layer manger (503) and proxy layers (506-507) with specific rules. A web extension (504) may communicate the rules for traffic manipulation of a user specified session to the proxy layer manager (503) via a web tab, device, or client. If proxy layer configurability is available for a target component, i.e. a proxy layers allowing traffic associated with that component, the proxy layer manager (503) may provide a configuration form where the user may choose custom destinations for various components and services. A configuration form may be a simple GUI that also allows a user to specify various rules, custom destinations, or canned responses. When a form is submitted, the proxy layer manager (503) may setup the rerouting of the communication and notify users of any possible errors. Also, the web extension (504) may provide expiration and header information associated with the request. This information may be attached to requests received to and from a browser tab (tab). A user may be notified of an expiring header to allow request of another header if needed. Multiple tabs, user sessions, or clients may each be configured differently and it may be the responsibility of the overall system to ensure the correct routing of traffic for each tab, user session, or client.

Proxy layers (506-507) may be configured to manage the communication between existing components in the system. Initially, proxy layers (500-507) may be set up to route traffic through the original component. During testing, the proxy layers (506-507) may be configured to dynamically, based on rules, route traffic through test components. For example, an HTTP Proxy Layer (506) may serve two functions. First, it may interface between a client and a server component and attach a trace id for all the requests between the components. Second, it may reroute the communication between front-end components. An RPC Proxy Layer (507), for example, may also be configured via the web front end (501) or web extension (504) and may reroute the communication between back-end components.

A proxy layer manager (503) may be a standalone service which may perform the following tasks: 1) configure the HTTP and RPC proxies (506, 507), 2) issue launch and shutdown commands so launch services requested by users for a specific change-list and associated test component, and 3) persist rerouting metadata information in the persistent storage (502).

A service manager (505) may launch and manage any components requested by users when setting up routing information via a WFE (501). The service may run on a secure and restricted server to address any potential concerns relating to security, privacy, production services, and data access policies.

The persistent storage (502) may keep history of routing information and other associated metadata for auditing, debugging, and reuse purposes information in persistent storage (502) may be persisted by the proxy layer manager (503). The stored information may also make the proxy layer manager (503) stateless and enable routing configuration of components dynamically. The temporary storage (508) may store logs of the proxy configurations and communication between components for a certain time period, such as fourteen days. For debugging purposes, communication between components may be captured, reported, logged, and stored. Access to storage may also be enabled with information related to the components for remote debugging.

FIG. 5B is a flow diagram of a configuration of a proxy layer via a web front end (501). A user may configure a proxy layer (506-507) using a web front end (501). A configuration request may include a unique identification for a session, client, and user. It may also include routing rules and other metadata associated with a particular configuration. The user may also set logging via the proxy layer (506-507). In step 551, a user, via the web front end (501), requests the proxy layer manager to generate a unique identifier. In step 553, the user via the web front (501) end sends rerouting configuration to the proxy layer manager (503). In step 554, the proxy layer manager (503) stores rerouting metadata from the request in persistent storage (502). In step 555, request the service manager (505) to launch test components to reroute traffic to the test component. This step launches the test target components to which the traffic might be routed through based on the configuration. In step 556, service manager (505) responds indicating test component may be routed to. In step 557, proxy layer manager (503) configures the routing information in the proxy layer (506-507) to route traffic to test component. In step 558, proxy layer manager (503) updates web front end (501) with updated proxy layer configuration. The web from end (501) may also display metadata associated with the updated proxy layer configuration.

FIG. 5C is a flow diagram of retrieving debug data via the web front end (501). In step 660, a web front end (501) requests the persistent storage (502) for session, data by a session's trace id. In step 661, the persistent storage (502) sends the session data of the trace id to the web front end (501). In step 662, the web front end (501) requests temp logs from temporary storage (508). In step 663, the temporary storage (508) sends temp logs, if available, to the web front end (501). In step 664, the web front end (501) aggregates and summarizes the received log information and displays it to the user.

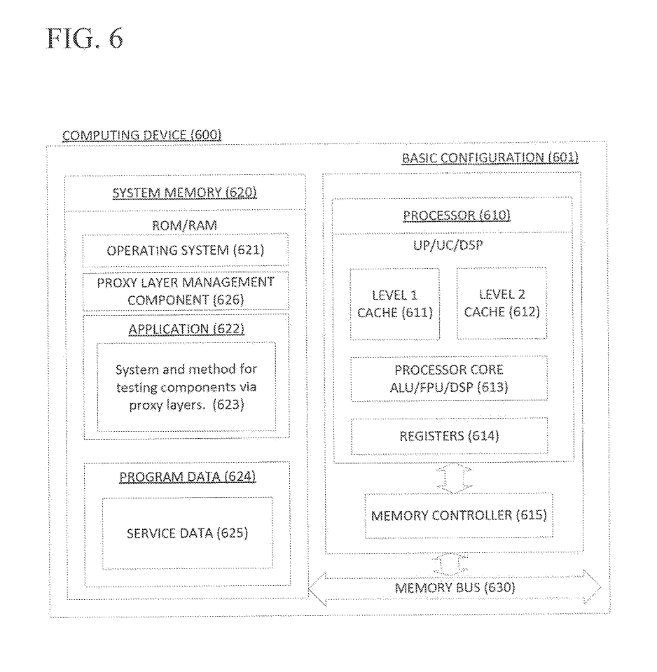

FIG. 6 is a high-level block diagram to show an application on a computing device (600). In a basic configuration (601), the computing device (600) typically includes one or more processors (610), system memory (620), and a memory bus (630). The memory bus is used to do communication between processors and system memory. The configuration may also include a standalone proxy layer management component (626) which implements the method described above, or may be integrated into an application (622, 623).

Depending on different configurations, the processor (610) can be a microprocessor (μP), a microcontroller (μC), a digital signal processor (DSP), or any combination thereof. The processor (610) can include one or more levels of caching, such as a L1 cache (611) and a L2 cache (612), a processor core (613), and registers (614). The processor core (613) can include an arithmetic logic unit (ALU), a floating point unit (FPU), a digital signal processing core (DSP Core), or any combination thereof. A memory controller (616) can either be an independent part or an internal part of the processor (610).

Depending on the desired configuration, the system memory (620) can be of any type including but not limited to volatile memory (such as RAM), non-volatile memory (such as ROM, flash memory, etc.) or any combination thereof. System memory (620) typically includes an operating system (621), one or more applications (622), and program data (624). The application (622) may include a proxy layer management component (626) or a system and method for testing components via proxy layers (623). Program Data (624) includes storing instructions that, when executed by the one or more processing devices, implement a system and method for the described method and component (623). Or instructions and implementation of the method may be executed via proxy layer management component (626). In some embodiments, the application (622) can be arranged to operate with program data (624) on an operating system (621).

The computing device (600) can have additional features or functionality, and additional interfaces to facilitate communications between the basic configuration (601) and any required devices and interfaces.

System memory (620) is an example of computer storage media. Computer storage media includes, but is not limned to, RAM, ROM, EEPROM, flash memory or other memory technology, CD-ROM, digital versatile disks (DVD) or other optical storage, magnetic cassettes, magnetic tape, magnet disk storage or other magnetic storage devices, or any other medium which can be used to store the desired information and which can be accessed by computing device 600. Any such computer storage media can be part of the device (600).

The computing device (600) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that includes any of the above functions. The computing device (600) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understand by those within site art that each function and/or operation within such block diagrams, flowcharts, or examples can be implemented, individually and or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs turning on one or more computers, as one or more programs running on one or more processors, as firmware, or as virtually any combination thereof, and that designing the circuitry and/or writing the code for the software and/or firmware would be well within the skill of one skilled in the art in light of this disclosure. In addition, those skilled in the art will appreciate that the mechanisms of the subject matter described herein are capable of being distributed as a program product in a variety of forms, and that an illustrate embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable a waveguide, a wired communications link, a wireless communication link, etc.)

With respect to the use of any plural and/or singular terms herein, those having skill in the art can translate from the plural to the singular and/or from the singular to the plural as is appropriate to the context and/or application. The various singular/plural permutations may be expressly set forth herein tor safe of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A method for testing a component in a software system, the method comprising:
establishing a target test environment which includes multiple components that interact with each other via proxy layers;
adding a test component having functionality that corresponds to a specific target component in the target test environment;
configuring the proxy layers associated with the specific target component to route traffic intended for the specific target component to the test component, and receive traffic from the test component;
executing one or more tests in the target test environment on the test component; and
routing traffic, via the proxy layers, between the test component and one or more components of the target test environment instead of the specific target component.

2. The method of claim 1, further comprising of a proxy layer manager to configure the routing settings of the proxy layers in the target test environment.

3. The method of claim 2, further comprising of a web front end for managing and configuring the routing settings of the proxy layer manager in the target test environment.

4. The method of claim 1, further comprising of a web front end for managing and configuring the routing settings of the proxy layers in the target test environment.

5. The method of claim 1, further comprising of applying routing-rules to the proxy layers for rule-based routing of traffic through the proxy layers.

6. The method of claim 5, wherein the routing-rules are configured to route traffic from some users to the test component and traffic from other users to the specific target component.

7. The method of claim 1, further comprising of generating trace and session data of traffic between the proxy layers.

8. The method of claim 1, further comprising of a service manager to launch and manage the test component in the target test environment.

9. The method of claim 1, wherein adding a test component includes adding multiple test components that each contain a portion of functionality of the specific target component in the target environment.

10. The method of claim 1, wherein adding a test component includes adding a single test component that contains functionalities of multiple specific target components in the target environment.

11. A proxy layer management system for testing a component in a software system, the system comprising:
one or more processing devices and one or more storage devices storing instructions that, when executed by the one or more processing devices, causes the one or more processing device to:
establish a target test environment which includes multiple components that interact with each other via proxy layers;
add a test component having functionality that corresponds to a specific target component in the target test environment;
configure the proxy layers associated with the specific target component to route traffic intended for the specific target component to the test component, and receive traffic from the test component;
execute one or more tests in the target test environment on the test component; and
route traffic, via the proxy layers, between the test component and one or more components of the target test environment instead of the specific target component.

12. The system of claim 11, further comprising of a proxy layer manager to configure the routing setting of the proxy layers in the target test environment.

13. The system of claim 12, further comprising of a web front end for managing and configuring the routing settings of the proxy layer manager in the target test environment.

14. The system of claim 11, further comprising of a web front end for managing and configuring the routing settings of the proxy layers in the target test environment.

15. The system of claim 11, further comprising of applying routing-rules to the proxy layers for rule-based routing of traffic through the proxy layers.

16. The system of claim 15, wherein the routing-rules are configured to route traffic from some users to the test component and traffic from other users to the specific target component.

17. The system of claim 11, further comprising of generating trace and session data of traffic between the proxy layers.

18. The system of claim 11, further comprising of a service manager to launch and manage the test component in the target test environment.

19. The system of claim 11, wherein adding a test component includes adding multiple test components that each contain a portion of functionality of the specific target component in the target environment.

20. The system of claim 11, wherein adding a test component includes adding a single test component that contains functionalities of multiple specific target components in the target environment.
